(19) United States
(12) Patent Application Publication
(10) Pub. No.: US 2024/0329873 A1
(43) Pub. Date: Oct. 3, 2024

(54) MANAGEMENT OF BUFFER UTILIZATION

(71) Applicant: Intel Corporation, Santa Clara, CA (US)

(72) Inventors: Ho-Ming LEUNG, Cupertino, CA (US); Salma Mirza JOHNSON, Littleton, MA (US); Jackson ELLIS, Fort Collins, CO (US); Daniel Christian BIEDERMAN, Saratoga, CA (US)

(21) Appl. No.: 18/736,227

(22) Filed: Jun. 6, 2024

(51) Int. Cl. G06F 3/06

(52) U.S. Cl. CPC G06F 3/0656; G06F 3/0604; G06F 3/0679

(57) ABSTRACT

Examples described herein relate to a device that includes: a host interface; and circuitry to: based on allocation of a region in a buffer, wherein the buffer is associated with Non-volatile Memory Express over Fabrics (NVMe-oF) transactions: based on a first size of compressed data to be stored in the buffer, deallocate a portion of the region in the buffer and store the compressed data of the first size into a second portion of the region in the buffer and based on a second size of the compressed data to be stored in the buffer, utilize the allocated region in the buffer to store the compressed data of the second size.

### BACKGROUND

Various protocols define manners of storing and retrieving data. For example, the Non-Volatile Memory Express (NVMe) specification describes a system for accesses to data storage systems through a Peripheral Component Interconnect Express (PCIe) port. NVMe is described, for example, in NVM Express™ Base Specification (2018). Non-volatile Memory Express over Fabrics (NVMe-oF™) specification describes a manner to copy data to virtualized storage nodes. For example, NVMe-oF™ is described at least in NVM Express, Inc., “NVM Express Over Fabrics” (2016).

### BRIEF DESCRIPTION OF THE DRAWINGS

FIG. 1 depicts an example system.

FIG. 2 depicts an example operation.

FIG. 3 depicts an example operation.

FIG. 4 depicts an example network interface device.

FIG. 5 depicts an example network interface device.

FIG. 6 depicts an example system.

### DETAILED DESCRIPTION

NVMe-oF transactions transfer data from a host system to a storage device via a network using protocols such as remote direct memory access (RDMA) or transfer data from the storage device to the host system. For NVMe-oF transactions, when data is copied to or from the host system, the data is temporarily stored in a bounce buffer, before being copied to the host system or transmitted in one or more packets to a destination storage device. A size of the bounce buffer scales with network bandwidth and a fixed amount of memory can be allocated to the bounce buffer. However, a limited size bounce buffer can limit a number of commands and associated data and can limit a number of outstanding transactions.

Various examples provide for allocation of a region in a bounce buffer at least for data to be written as part of an NVMe-oF write transaction or data to be read as part of an NVMe-oF read transaction. Prior to storage of the data into the bounce buffer, the data can be compressed using one or more compression technologies. Based on a size of the compressed data being less than that of the allocated region, a portion of the region in the bounce buffer can be deallocated and made available for use by another write or read transaction. The bounce buffer can be allocated using multiple pointers, where a pointer refers to a subregion (e.g., a strict subset of the bounce buffer). Deallocation of the portion of the region can include identifying a pointer to a strict subset of the bounce buffer for reallocation to another write or read transaction. Based on a size of the compressed data being approximately a size of the allocated region, or such that no subregion of the bounce buffer would not store compressed data, the allocated region in the buffer can be used to store the compressed data. Based on a size of the compressed data being greater than a size of the allocated region, the allocated region in the buffer can be increased and the increased size allocated region can be used to store the compressed data. Some examples can allocate a size of a bounce buffer for transactions that utilize one or more of: a network interface device, an accelerator, or a storage controller.

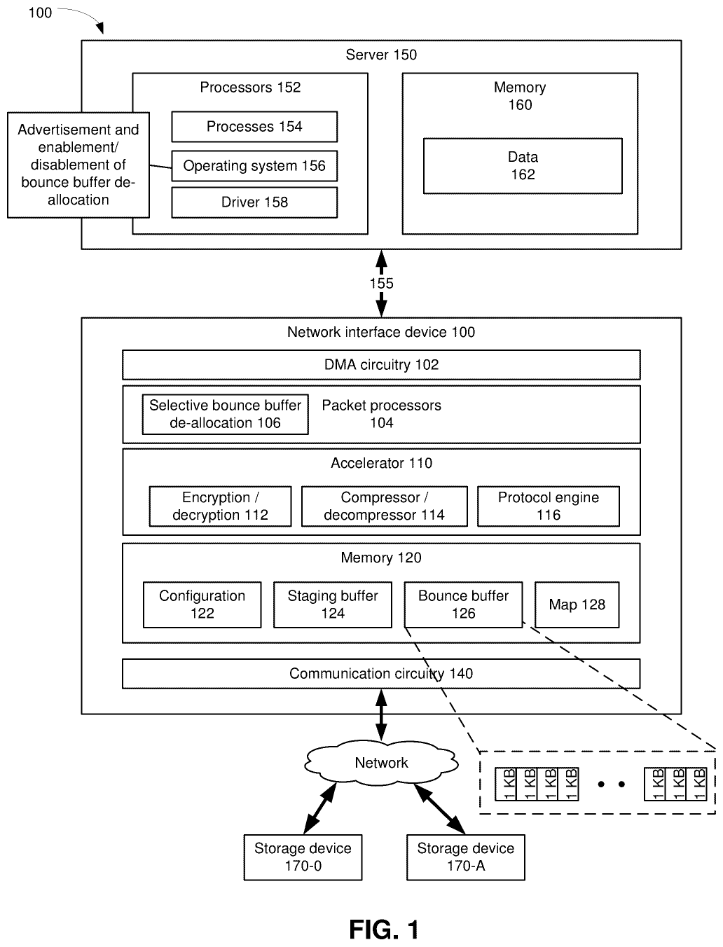

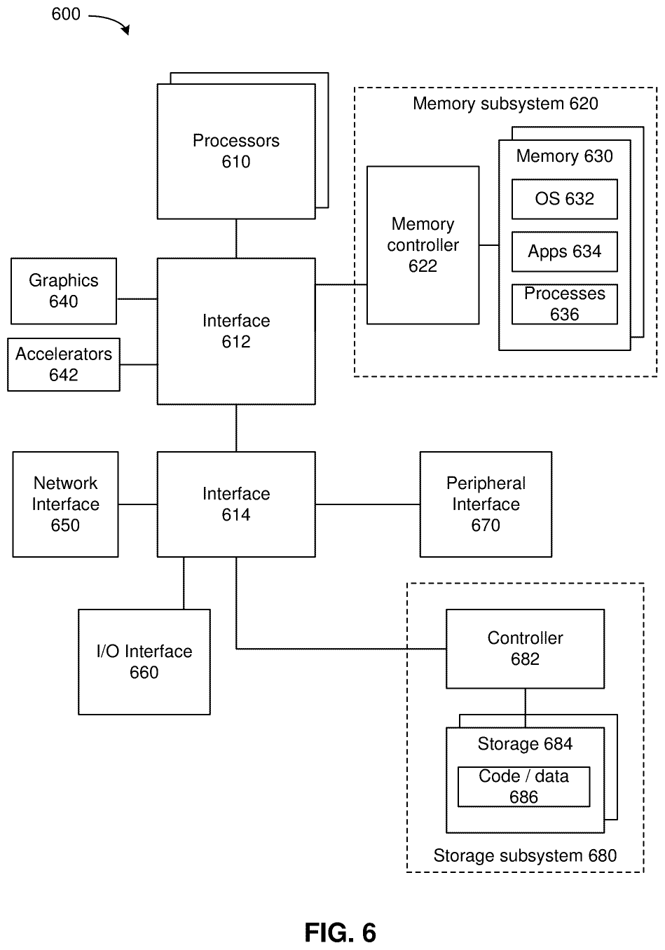

FIG. 1 depicts an example system. Server 150 can be coupled to network interface device 100 using a device interface 155 (e.g., Peripheral Component Interconnect express (PCIe), Compute Express Link (CXL), or others) or network connection, examples of which are described herein. Server 150 can include processors 152, memory 160, and other circuitry and/or software described herein at least with respect to the system of FIG. 6. Processors 152 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), or other circuitry.

Processors 152 can execute processes 154. Processes 154 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some processes can perform video processing or media transcoding (e.g., changing the encoding of audio or image or video files).

Processors 152 can execute operating system 156 and/or driver 158. Processes 154 can call an application programming interface (API) to communicate with operating system 156 and/or driver 158 to discover capability of network interface device 100 to selectively de-allocate one or more subregions of a bounce buffer (e.g., bounce buffer 126) based on the one or more subregions not being used to store compressed data. Operating system 156 and/or driver 158 can enable or disable packet processors 104 and accelerator 110 of network interface device 100 to selectively de-allocate one or more subregions of bounce buffer 126 by configuration 122. Configuration 122 can be loaded into memory 120 of network interface device 100 by operating system 156, driver 158, or a data center administrator using an application programming interface (API), configuration file, or other communication.

In some examples, such as where compression of encrypted data does not reduce a size of encrypted data more than a level, capability of network interface device 100 to selectively de-allocate one or more subregions of a bounce buffer (e.g., bounce buffer 126), based on the one or more subregions not being used to store compressed data, can be disabled.

Packet processors 104 and/or accelerator 110 can process data to be transmitted to a storage node or received from a storage node by performing one or more of: encryption, decryption, data compression, data decompression, data or device authentication, next hop determination, error value checking (e.g., cyclic redundancy check (CRC) or checksum), trust verification, or others.

For example, one or more of encryption/decryption 112 can encrypt data received from data received from server 150 prior to storage in memory 120 and prior to transmission in one or more packets by network interface device 100 to one or more of storage devices 150-0 to 150-A, where A is an integer. For example, one or more of encryption/decryption 112 can decrypt data received in one or more packets by network interface device 100 from one or more of storage devices 150-0 to 150-A before or after storage in memory 120.

For example, one or more of compressors/decompressors 114 can perform lossless or lossy compression of data stored in staging buffer 124 prior to storage in bounce buffer 126. One or more of compressors/decompressors 114 can perform lossless or lossy compression of data prior to transmission in one or more packets by communication circuitry 140 to a storage device or prior to copying the data through interface 155 to memory 160. Compression and decompression techniques can include at least: Lempel Ziv (LZ) family of compression schemes including LZ77, LZ78, LZA, Zstandard (ZSTD), DEFLATE, and Snappy standards and derivatives, among others. In some examples, different compression and/or encryption techniques can be used for data transmitted in packets than on data stored in memory 120.

One or more of compressors/decompressors 114 can store compressed data into staging buffer 124 and then copy compressed data from staging buffer 124 into bounce buffer 126 until full and then block further copies to bounce buffer 126. Map 128 can indicate a storage location in bounce buffer 126, size of the data, and compression technology applied. Based on a read of data from bounce buffer 126, one or more of compressors/decompressors 114 can retrieve compressed data and decompress the compressed data based on map 128.

In some examples, one or more of compressors/decompressors 114 can apply multiple different compression techniques to data and compressed data to be stored in bounce buffer 126 can be selected based on a compression ratio or percentage reduction in size of data. An indicator of compression technology used to compress data can be stored in map 128.

Bounce buffer 126 can be allocated in memory 120 as a pool of multiple subregions. For example, a subregion can be 1 KB in size, and multiple subregions can be allocated to DMA circuitry 102 to store data before and after compression of data. However, other sizes of subregions can be used. Based on compression of data, a size of data stored in bounce buffer 126 may shrink and based on configuration 122, where a size of the compressed data is less than allocated region in bounce buffer 126 and at least one subregion is not used to store the compressed data, packet processors 104 can deallocate at least one subregion in bounce buffer 126 so that pointer(s) to such at least one subregion can be available for use for data of other transactions. For example, data can include an NVMe-oF command and/or data received in a packet or to be transmitted in a packet. Accordingly, a number of transactions that can utilize bounce buffer 126 can potentially increase where subregions of bounce buffer 126 are deallocated and available for use. A bit map or data may be used to identify subregions available for allocation.

For example, bounce buffer 126 can include four 1 KiB subregions. Where a first data of size 4 KiB is compressed by 10× to 0.4 KiB and stored in only one 1 KiB subregion, the three unused 1 KiB sub regions can be freed for other transactions. Where a second data is compressed to 3.5 KiB, all four subregions are used to store the 3.5 KiB compressed data and no sub-region can be freed in this case.

Based on configuration 122, packet processors 104 can be configured to perform match-action operations on received packets to identify packet processing rules and next hops using information stored in a ternary content-addressable memory (TCAM) tables or exact match tables in some examples. Configuration 122 can be based on one or more of: OneAPI, Programming protocol independent packet processors (P4), Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, OpenConfig, NETCONF, RESTconf API, x86 compatible executable binaries, or other executable binaries.

In some examples, network interface device 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An EPU can include a network interface device that utilizes processors and accelerators (e.g., digital signal processors (DSPs), signal processors, or wireless specific accelerators for Virtualized radio access networks (vRANs), cryptographic operations, compression/decompression, and so forth). A network interface device can include: one or more processors; one or more programmable packet processing pipelines; one or more accelerators; one or more application specific integrated circuits (ASICs); one or more field programmable gate arrays (FPGAs); one or more memory devices; one or more storage devices; or others.

Accelerator 110 can include or perform protocol engine 116. In some examples, a read command can be issued by server 150 for transmission by network interface device 100 to one or more of storage devices 170-0 to 170-A. In some examples, a write command can be issued by server 150 for transmission by network interface device 100 to one or more of storage devices 170-0 to 170-A. In some examples, the read command and/or write command can be consistent with NVMe or NVMe-oF and protocol engine 116 can process the read command and/or write command based on semantics of NVMe or NVMe-oF.

Packet processors 104 and/or accelerator 110 can be implemented as one or more of: a processor core, field programmable gate array (FPGA), a processor that executes instructions, firmware, application specific integrated circuit (ASIC), or other circuitry.

A packet may be used herein to refer to various formatted collections of bits that may be sent across a network. A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using n-tuples (e.g., source address, destination address, IP protocol, transport layer source port, and/or destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

Communication circuitry 140 can provide communications with other devices over a network or fabric via one or more ports. Communication circuitry 140 may be configured to use any one or more communication technology (e.g., wired or wireless communications) and associated protocols (e.g., Ethernet, InfiniBand®, Bluetooth®, Wi-Fi®, 4G LTE, 5G, Ultra Ethernet, etc.) to perform such communication. Communication circuitry 140 can include one or more network hardware resources, such as ingress queues, egress queues, crossbars, shared memory switches, media access control (MAC), physical layer interface (PHY), Ethernet port logic, and other network hardware resources.

Although examples are provided with respect to a network interface device, other devices can be used instead or in addition, such as a storage controller, memory controller, fabric interface, processor, and/or accelerator device.

Although examples have been described herein with respect to NVMe-oF, other technologies can be used such as RDMA, Transmission Control Protocol (TCP), User Datagram Protocol (UDP), quick UDP Internet Connections (QUIC), RDMA over Converged Ethernet (ROCE), RoCE v2, or others. The utilized protocol could be time aware, such that the protocol apply a start time, end time, and or a data rate (e.g., time aware RDMA or time aware NVMe).

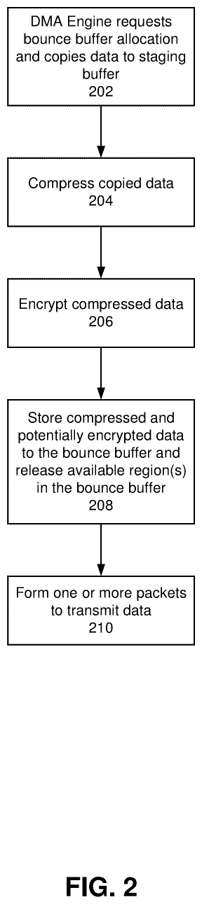

FIG. 2 depicts an example write operation. The write operation can include an NVMe-oF write operation. The write operation can be performed by a network interface device, an accelerator, or a storage controller. At 202, a DMA circuitry could request and receive, from an operating system (OS), allocation of multiple pointers to a subset of a bounce buffer. For example, 4 pointers to different 1 KB (or 512B or other sizes) regions can be allocated. In some examples, an NVMe command (nCMD) is allocated 4 KB in a bounce buffer. However, other sizes of bounce buffer can be allocated. At 202, DMA engine can transfer data from a host to a staging buffer prior to storage in the allocated bounce buffer.

At 204, one or more compression engines can apply different lossless or lossy compression algorithms in parallel. Compressed data can be selected based on compressed data with a highest compression ratio or which reduced data in size by a largest amount. For example, a particular compression technology can compress video or audio more than when applied to plain text. Where video is to be compressed, the particular compression technology can be applied to compress the video. In some examples, certain types of data may not use certain compression schemes to save power. At 206, the compressed data can be encrypted, in some examples. At 208, the compressed data (and potentially encrypted data) can be stored into the bounce buffer. After determination of the size of compressed data, unused subregion(s) in the bounce buffer can be made available and deallocated and returned to a free pool. A bit map can be updated to identify unused subregions in bounce buffer.

At 210, packets with compressed or decompressed data (and potentially encrypted data) can be formed. The compression technique used and compressed data size could be stored in the nCMD sent to network protocol engines (e.g., NVMe module) to indicate a decompression technique to apply to decompress data. The indication of decompression technique can be provided to a protocol engine to decompress data prior to transmission in one or more packets or to a receiver to apply to decompress the data received in one or more packets.

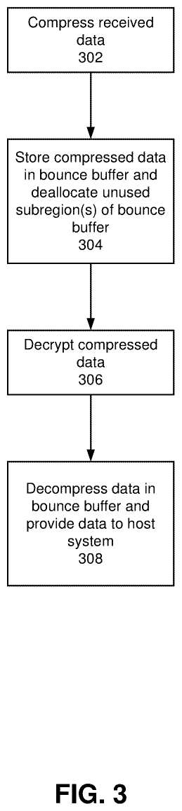

FIG. 3 depicts an example read operation. The read operation can include an NVMe-oF read operation. The read operation can be performed by a processor (e.g., CPU or GPU), a network interface device, an accelerator, or a storage controller. At 302, based on receipt of a packet (e.g., Ethernet packet), data in the packet can be compressed after receipt. Compression engines can operate in parallel and compressed data with a highest compression ratio can be selected to be stored in a bounce buffer. The size of compressed data could be provided as part of an NVMe completion status to a processor.

At 304, the compressed data can be stored into a bounce buffer. In some examples, a network protocol engine that processes received commands could request allocation of a bounce buffer. An operating system (OS) can allocate the bounce buffer as multiple subregions. At 304, compressed data can be stored in the bounce buffer and unused subregion(s) of the bounce buffer, which do not store compressed data, pointers to the unused subregions can be deallocated.

At 306, where compressed data is encrypted, the encrypted compressed data can be decrypted. At 308, the decompressed data can be copied by a DMA circuitry to a memory of a host system. For example, the DMA circuitry can decompress data copied from the bounce buffer and copy the decompressed data to the memory of the host system.

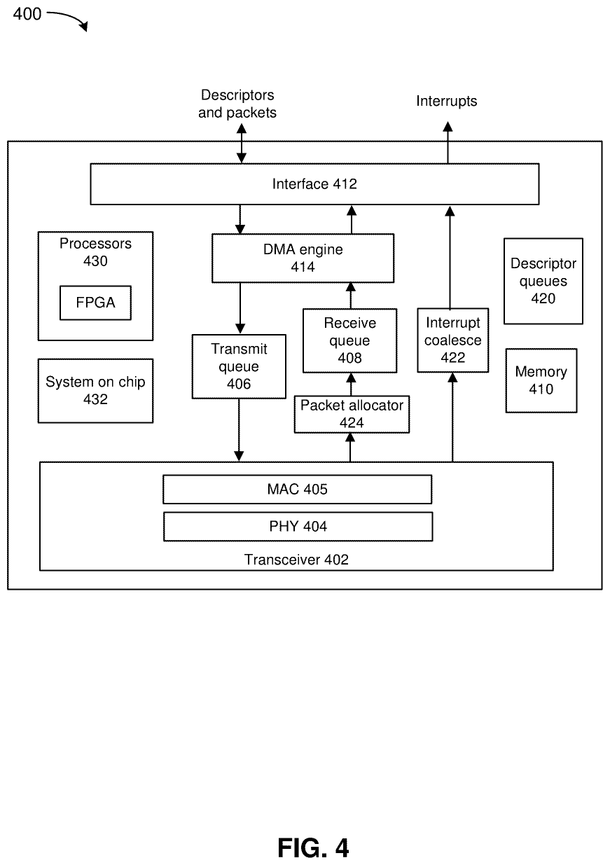

FIG. 4 depicts an example network interface device. In some examples, processors and/or FPGAs 430 can be configured to deallocate available region(s) of a bounce buffer, as described herein. Some examples of network interface 400 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable circuitries or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 430, transmit queue 406, receive queue 408, memory 410, and host interface 412, and DMA engine 414. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 404 and media access control (MAC) circuitry 405. PHY circuitry 404 can include encoding and decoding circuitry (not shown) to encode and decode data packets according to applicable physical layer specifications or standards. MAC circuitry 405 can be configured to perform MAC address filtering on received packets, process MAC headers of received packets by verifying data integrity, remove preambles and padding, and provide packet content for processing by higher layers. MAC circuitry 405 can be configured to assemble data to be transmitted into packets, that include destination and source addresses along with network control information and error detection hash values.

Processors 430 can be one or more of: combination of: a processor, core, graphics processing unit (GPU), field programmable gate array (FPGA), application specific integrated circuit (ASIC), or other programmable hardware device that allow programming of network interface 400. For example, a “smart network interface” or SmartNIC can provide packet processing capabilities in the network interface using processors 430.

Processors 430 can include a programmable processing pipeline or offload circuitries that is programmable by P4, Software for Open Networking in the Cloud (SONIC), Broadcom® Network Programming Language (NPL), NVIDIA® CUDAR, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content. Processors 430 can be configured to deallocate available region(s) of a bounce buffer, as described herein.

Packet allocator 424 can provide distribution of received packets for processing by multiple CPUs or cores using receive side scaling (RSS). When packet allocator 424 uses RSS, packet allocator 424 can calculate a hash or make another determination based on contents of a received packet to determine which CPU or core is to process a packet.

Interrupt coalesce 422 can perform interrupt moderation whereby interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into segments of a packet. Network interface 400 provides this coalesced packet to an application.

Direct memory access (DMA) engine 414 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be volatile and/or non-volatile memory device and can store any queue or instructions used to program network interface 400. Transmit traffic manager can schedule transmission of packets from transmit queue 406. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Bus interface 412 can provide an interface with host device (not depicted). For example, bus interface 412 can be compatible with or based at least in part on PCI, PCIe, PCI-x, Serial ATA, and/or USB (although other interconnection standards may be used), or proprietary variations thereof.

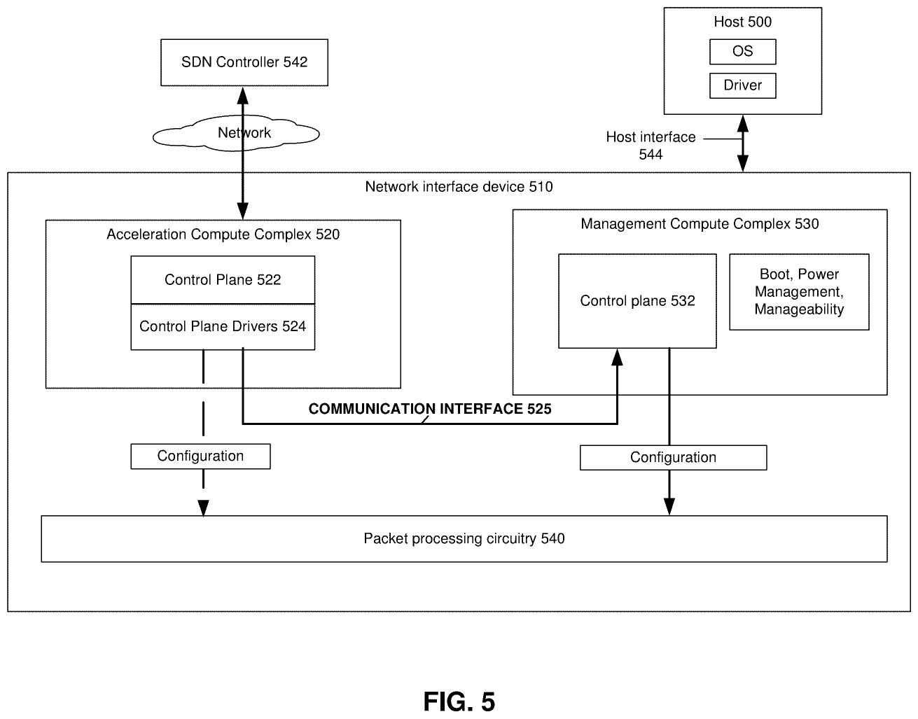

FIG. 5 depicts an example network interface device. Host 500 can include processors, memory devices, device interfaces, as well as other circuitry, such as those described herein. Processors of host 500 can execute software such as applications (e.g., microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes.

Packet processing device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to herein. Similarly, MCC 530 can be implemented as one or more of: a microprocessor, processor, accelerator, field programmable gate array (FPGA), application specific integrated circuit (ASIC) or circuitry described herein. In some examples, ACC 520 and MCC 530 can be implemented as separate cores in a CPU, different cores in different CPUs, different processors in a same integrated circuit, different processors in different integrated circuit.

Packet processing device 510 can be implemented as one or more of: a microprocessor, processor, accelerator, field programmable gate array (FPGA), application specific integrated circuit (ASIC) or circuitry described herein. Packet processing circuitry 540 can process packets as directed or configured by one or more control planes executed by multiple compute complexes. In some examples, ACC 520 and MCC 530 can execute respective control planes 522 and 532.

Packet processing device 510, ACC 520, and/or MCC 530 can be configured to deallocate available region(s) of a bounce buffer, as described herein.

SDN controller 542 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 542 to configure operation of packet processing circuitry 540. Control plane application 522 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 542 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 542 can provide packet processing rules for performance by ACC 520. For example, ACC 520 can program table rules (e.g., header field match and corresponding action) applied by packet processing circuitry 540 based on change in policy and changes in VMs, containers, microservices, applications, or other processes. ACC 520 can be configured to provide network policy as flow cache rules into a table to configure operation of packet processing 540. For example, the ACC-executed control plane application 522 can configure rule tables applied by packet processing circuitry 540 with rules to define a traffic destination based on packet type and content. ACC 520 can program table rules (e.g., match-action) into memory accessible to packet processing circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing circuitry 540 as to which VM is to receive traffic and what kind of traffic a VM can transmit. For example, packet processing circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to Baseboard Management Controller (BMC), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing circuitry 540 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 520 or MCC 530. In some examples, a P4 program can be compiled and provided to MCC 530 to configure packet processing circuitry 540.

FIG. 6 depicts a system. In some examples, circuitry of system 600 can configure network interface device 650 to deallocate available region(s) of a bounce buffer, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can enable or disable network interface 650 to deallocate available region(s) of a bounce buffer, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), RoCE v2, Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute platforms of processors, memories, storages, network interfaces, and other components. High speed interconnects can be used such as PCIe, CXL, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a device comprising: a host interface; and circuitry to: based on allocation of a region in a buffer, wherein the buffer is associated with Non-volatile Memory Express over Fabrics (NVMe-oF) transactions: based on a first size of compressed data to be stored in the buffer, deallocate a portion of the region in the buffer and store the compressed data of the first size into a second portion of the region in the buffer and based on a second size of the compressed data to be stored in the buffer, utilize the allocated region in the buffer to store the compressed data of the second size.

Example 2 includes one or more examples, wherein the buffer comprises a bounce buffer.

Example 3 includes one or more examples, wherein the data comprises a command and/or data.

Example 4 includes one or more examples, wherein the device comprises one or more of: a network interface device, an accelerator, or a storage controller.

Example 5 includes one or more examples, wherein the device comprises a network interface device and the network interface device comprises a network interface and a direct memory access (DMA) circuitry.

Example 6 includes one or more examples, wherein: the circuitry is to: in response to receipt of a write command associated with a first data: based on compression of the first data, deallocate at least one of a first group of multiple pointers based on a size of the compressed first data; and in response to receipt of a read command associated with a second data received in at least one packet by the interface: based on compression of the second data, deallocate at least one of a second group of multiple pointers based on a size of the compressed second data.

Example 7 includes one or more examples, wherein: the write command comprises a Non-volatile Memory Express over Fabrics (NVMe-oF) write command and the read command comprises an NVMe-oF read command.

Example 8 includes one or more examples, and includes a second circuitry to apply at least one compression scheme to the first data prior to storage into the buffer, wherein the at least one compression scheme comprises at least one of: Lempel Ziv (LZ) LZ77, LZ78, LZ4, Zstandard (ZSTD), DEFLATE, or Snappy standards.

Example 9 includes one or more examples, and includes a second circuitry to decompress the compressed first data prior to transmission in one or more packets by the device.

Example 10 includes one or more examples, and includes a second circuitry to decompress the compressed second data prior to a copy of the decompressed second data by a direct memory access (DMA) circuitry to a host system.

Example 11 includes one or more examples, and includes a method that includes: a network interface device performing: in response to receipt of a write command associated with a first data: receiving allocation of a first group of multiple pointers to multiple regions of a buffer; and based on compression of the first data, deallocating at least one of the first group of multiple pointers based on a size of the compressed first data; and in response to receipt of a read command associated with a second data received in at least one packet by the network interface: receiving allocation of a second group of multiple pointers to multiple regions of the buffer; and based on compression of the second data, deallocating at least one of the second group of multiple pointers based on a size of the compressed second data.

Example 12 includes one or more examples, wherein: the write command comprises a Non-volatile Memory Express over Fabrics (NVMe-oF) write command and the read command comprises an NVMe-oF read command.

Example 13 includes one or more examples, and includes applying at least one compression scheme to the first data prior to storage into the buffer, wherein the at least one compression scheme comprises at least one of: Lempel Ziv (LZ) LZ77, LZ78, LZA, Zstandard (ZSTD), DEFLATE, or Snappy standards.

Example 14 includes one or more examples, and includes decompressing the compressed first data prior to transmission in one or more packets by the network interface.

Example 15 includes one or more examples, and includes decompressing the compressed second data prior copying the decompressed second data by a direct memory access (DMA) circuitry to a host system.

Example 16 includes one or more examples, and includes at least one non-transitory computer-readable medium comprising instructions stored thereon, that if executed by one or more processors, cause the one or more processors to: execute a driver that is to configure a network interface device to: based on a first size of compressed data to be stored in a buffer, deallocate a portion of a region in the buffer and store the first size of compressed data into a second portion of the region in the buffer and based on a second size of the compressed data to be stored in the buffer, utilize the region in the buffer to store the second size of the compressed data.

Example 17 includes one or more examples, wherein the buffer comprises a bounce buffer.

Example 18 includes one or more examples, wherein the device comprises one or more of: a network interface device, an accelerator, or a storage controller.

Example 19 includes one or more examples, and includes instructions stored thereon, that if executed by one or more processors, cause the one or more processors to: execute the driver that is to configure the network interface device to: apply at least one compression scheme to the first data prior to storage into the buffer, wherein the at least one compression scheme comprises at least one of: Lempel Ziv (LZ) LZ77, LZ78, LZA, Zstandard (ZSTD), DEFLATE, or Snappy standards.

Example 20 includes one or more examples, wherein the data is accessed using a Non-volatile Memory Express over Fabrics (NVMe-oF) read command.

What is claimed is:

1. An apparatus comprising:
a device comprising:
a host interface; and
circuitry to:
based on allocation of a region in a buffer, wherein the buffer is associated with Non-volatile Memory Express over Fabrics (NVMe-oF) transactions:
based on a first size of compressed data to be stored in the buffer, deallocate a portion of the region in the buffer and store the compressed data of the first size into a second portion of the region in the buffer and
based on a second size of the compressed data to be stored in the buffer, utilize the allocated region in the buffer to store the compressed data of the second size.

2. The apparatus of claim 1, wherein the buffer comprises a bounce buffer.

3. The apparatus of claim 1, wherein the data comprises a command and/or data.

4. The apparatus of claim 1, wherein the device comprises one or more of: a network interface device, an accelerator, or a storage controller.

5. The apparatus of claim 1, wherein the device comprises a network interface device and the network interface device comprises a network interface and a direct memory access (DMA) circuitry.

6. The apparatus of claim 1, wherein:
the circuitry is to:
in response to receipt of a write command associated with a first data: based on compression of the first data, deallocate at least one of a first group of multiple pointers based on a size of the compressed first data; and
in response to receipt of a read command associated with a second data received in at least one packet by the interface: based on compression of the second data, deallocate at least one of a second group of multiple pointers based on a size of the compressed second data.

7. The apparatus of claim 6, wherein:
the write command comprises an NVMe-oF write command and
the read command comprises an NVMe-oF read command.

8. The apparatus of claim 6, comprising:
a second circuitry to apply at least one compression scheme to the first data prior to storage into the buffer, wherein the at least one compression scheme comprises at least one of: Lempel Ziv (LZ) LZ77, LZ78, LZ4, Zstandard (ZSTD), DEFLATE, or Snappy standards.

9. The apparatus of claim 6, comprising:
a second circuitry to decompress the compressed first data prior to transmission in one or more packets by the device.

10. The apparatus of claim 6, comprising:
a second circuitry to decompress the compressed second data prior to a copy of the decompressed second data by a direct memory access (DMA) circuitry to a host system.

11. A method comprising:
a network interface device performing:
in response to receipt of a write command associated with a first data:
receiving allocation of a first group of multiple pointers to multiple regions of a buffer; and
based on compression of the first data, deallocating at least one of the first group of multiple pointers based on a size of the compressed first data; and
in response to receipt of a read command associated with a second data received in at least one packet by the network interface:
receiving allocation of a second group of multiple pointers to multiple regions of the buffer; and
based on compression of the second data, deallocating at least one of the second group of multiple pointers based on a size of the compressed second data.

12. The method of claim 11, wherein:
the write command comprises a Non-volatile Memory Express over Fabrics (NVMe-oF) write command and
the read command comprises an NVMe-oF read command.

13. The method of claim 11, comprising:
applying at least one compression scheme to the first data prior to storage into the buffer, wherein the at least one compression scheme comprises at least one of: Lempel Ziv (LZ) LZ77, LZ78, LZ4, Zstandard (ZSTD), DEFLATE, or Snappy standards.

14. The method of claim 11, comprising:
decompressing the compressed first data prior to transmission in one or more packets by the network interface.

15. The method of claim 11, comprising:
decompressing the compressed second data prior copying the decompressed second data by a direct memory access (DMA) circuitry to a host system.

16. At least one non-transitory computer-readable medium comprising instructions stored thereon, that if executed by one or more processors, cause the one or more processors to:
execute a driver that is to configure a network interface device to:
based on a first size of compressed data to be stored in a buffer, deallocate a portion of a region in the buffer and store the first size of compressed data into a second portion of the region in the buffer and
based on a second size of the compressed data to be stored in the buffer, utilize the region in the buffer to store the second size of the compressed data.

17. The at least one non-transitory computer-readable medium of claim 16, wherein the buffer comprises a bounce buffer.

18. The at least one non-transitory computer-readable medium of claim 16, wherein the device comprises one or more of: a network interface device, an accelerator, or a storage controller.

19. The at least one non-transitory computer-readable medium of claim 16, comprising instructions stored thereon, that if executed by one or more processors, cause the one or more processors to:
execute the driver that is to configure the network interface device to:
apply at least one compression scheme to the first data prior to storage into the buffer, wherein the at least one compression scheme comprises at least one of: Lempel Ziv (LZ) LZ77, LZ78, LZ4, Zstandard (ZSTD), DEFLATE, or Snappy standards.

20. The at least one non-transitory computer-readable medium of claim 16, wherein the data is accessed using a Non-volatile Memory Express over Fabrics (NVMe-oF) read command.
